(19) United States
(12) Patent Application Publication
(10) Pub. No.: US 2011/0278405 A1
(43) Pub. Date: Nov. 17, 2011

(54) Device for supporting a suction element

(76) Inventors: Sam Zhadanov, Brooklyn, NY (US); Eli Zhadanov, Brooklyn, NY (US)

(21) Appl. No.: 12/800,406

(22) Filed: May 15, 2010

(51) Int. Cl. F16B 47/00; F16M 13/02

(52) U.S. Cl. 248/205.4; 248/205.1; 248/205.5

(57) ABSTRACT

A device for supporting on a surface a part having a suction element includes a mounting element having a wall mountable on the surface, and a pocket-shaped receptacle for receiving the suction element, such that when the suction element is received in the pocket-shaped receptacle and the wall is attached to the surface, the part is supported on the surface.

### BACKGROUND OF THE INVENTION

The present invention relates to devices for supporting parts on a surface, for example parts, in particular suction elements, used for showering, bathing, and the like.

It is known to provide a supporting device which has a mounting member for holding a part and having a structure allowing the mounting member to be attached to a surface of a structure, so as to support the part. In some applications it is however desirable to provide additional mounting possibilities for supporting the part on the surface. It is believed that therefore the existing devices of this type can be further improved.

### SUMMARY OF THE INVENTION

Accordingly, it is an object of the present invention to provide a device for supporting a part on a surface, which is a further improvement of the existing devices.

In keeping with these objects and with others which will become apparent hereinafter, one feature of the present invention resides, briefly stated, in a device for supporting on a surface a part having a suction element, the device comprising a mounting element having a wall mountable on the surface; and a pocket-shaped receptacle for receiving the suction element, such that when the suction element is received in the pocket-shaped receptacle and the wall is attached to the surface, the part is supported on the surface.

Another feature of the present invention resides, briefly stated, in said wall provided with means for attaching the mounting element of the surface, including adhesive means.

A further feature of the present invention resides in a protective element which covers the adhesive means when not in use, and is removable from the wall so as to expose the adhesive means of the wall to mount the wall on the surface.

A further feature of the present invention resides in said suction element having a further wall which is spaced from said first mentioned wall so as to form said pocket-shaped receptacle therebetween.

A further feature of the present invention resides in said further wall having a slot for receiving a projection of the suction element when the suction element is inserted in said pocket-shaped receptacle of said mounting element.

A further feature of the present invention resides in said suction element having an axis, and said pocket-shaped receptacle being open at one radial side and substantially closed at the other radial side to prevent its sliding further through and out of the receptacle.

A further feature of the present invention resides in a further wall which is spaced from said first mentioned wall so as to form said pocket-shaped receptacle therebetween; and a partially peripheral wall which closes said pocket-shaped receptacle at side other side.

A further feature of the present invention resides in said suction element being a flexible member so that when it is insertable in said pocket-shaped receptacle it is compressed and firmly held in said pocket-shaped receptacle.

A further feature of the present invention resides in said suction element being formed to be also mountable on the surface when not inserted in the pocket-shaped receptacle of the mounting element.

When the device is designed in accordance with the present invention, it is possible to mount the part on a surface with the suction element only, or to mount the part with the mounting element when the suction element is inserted in the pocket-shaped receptacle of the mounting element.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a front view of a mounting element of the inventive device for supporting a part;

FIG. 2 is a side view of the mounting element;

FIG. 3 is a side view of a suction element on the inventive device with a part supported by it; and

FIG. 4 is a cross-section of the inventive device including the suction element, the mounting element, and a part supported thereby.

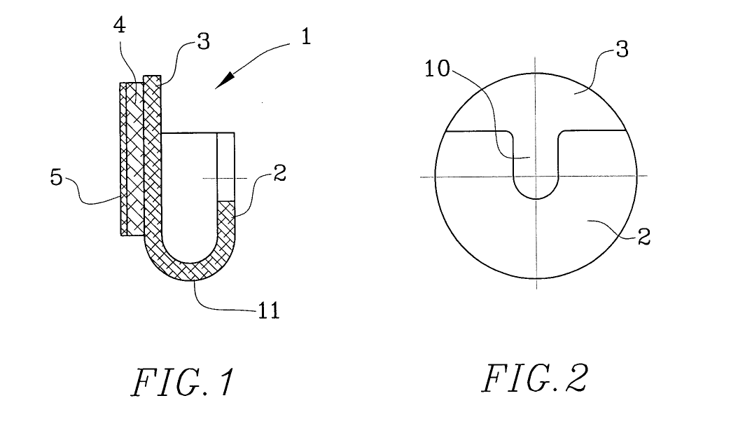

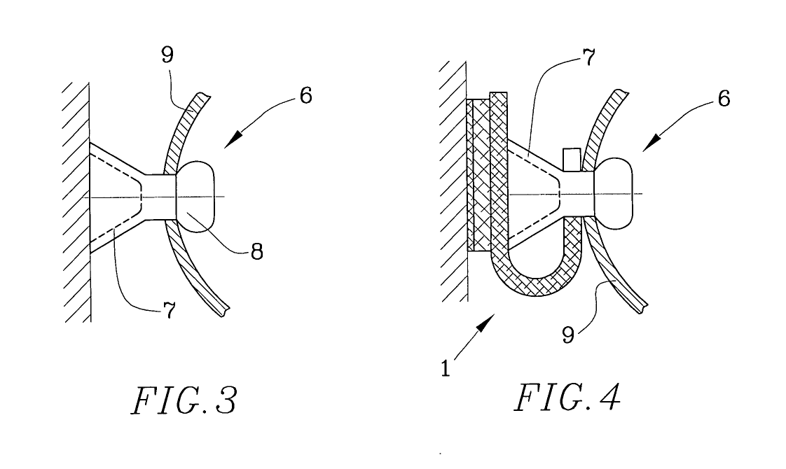

### DESCRIPTION OF THE PREFERRED EMBODIMENTS

A device for supporting a part on a surface in accordance with the present invention includes a mounting element which is identified as a whole with reference numeral 1. The mounting element 1 can be formed for example as a substantially circular element having an axis. It has two walls 2 and 3 which are spaced from one another and in an axial direction and form a pocket-shaped receptacle therebetween.

Means for attaching the mounting element 1 to a surface is identified with reference numeral, and can be formed for example as an adhesive layer 4 provided on the wall 3 of the mounting element 1. In a non-used condition the adhesive layer 4 is covered by a protective layer 5 formed for example as a peelable off layer of paper, plastic and the like. For attaching the mounting element 1 to a surface, for example to a surface of the wall, the protective layer 5 is removed, and the wall 3 with the adhesive layer 4 is pressed against the wall to adhesively attach the mounting element to the surface.

The device for supporting a part in accordance with the present invention further has a suction element which is identified with reference numeral 6. The suction element 6 can be provided with a first part 7, which can be formed for example as an elastic part and possibly in a shape of an elastic cup, and also a projection 8 which is insertable into an opening of a part 9 to be supported and held in it. The projection 8 can pass through the opening of the part 9 because it is also elastic, and then engage the part 9 from the opposite side.

In various applications it is possible to press the suction element 6 against the surface so that the cup-shaped part 7 attaches with the suction action to the surface, and the suction element itself holds the part 9 on the surface. If however this is not possible or desirable in view of significant roughness of the surface and other considerations, the mounting element 1 is used for supporting the part 9. For this purpose the elastic part 7 of the suction element 6 is introduced into the pocket-shaped receptacle of the mounting element 1 and compressed because of its elastic properties to be reliably held in the receptacle. The assembly is then attached to the surface by interaction of the adhesive layer 4 with the surface as shown in FIG. 4.

As shown in FIG. 2, the mounting element 1 in its wall 2 is provided with a slot 10 through which the narrow portion of the elastic part 8 of the mounting member 6 can pass during insertion of the suction element 6 into the pocket-shaped receptacle of the mounting element 1. The slot 10 is substantially U-shaped.

The pocket-shaped receptacle is open at one radial side which is an upper side in FIG. 2, and is substantially closed at the other opposite radial side, which is a lower side in. At the lower side the mounting element 1 has a partially circumferential wall 11 which extends over a certain angle around the axis of the mounting element 1.

It will be understood that each of the elements described above, or two or more together, may also find a useful application in other types of constructions differing from the type described above.

While the invention has been illustrated and described as embodied in device for supporting a part, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1-9. (canceled)

10. A device for supporting a part on a surface, comprising a suction element connectable to the part; and a mounting element having a first wall directly mountable on the surface and a pocket-shaped receptacle receiving the suction element, such that when the suction element which supports the part is received in the pocket-shaped receptacle of said mounting element and the first wall of the mounting element is mounted on the surface, the part is supported on the surface through the suction element and through the mounting element.

11. A device as defined in claim 10, wherein said first wall is provided with means for mounting it on the surface, including an adhesive layer provided on said first wall.

12. A device as defined in claim 11; and further comprising a protective element which covers the adhesive layer when not in use, and is removable from said adhesive layer so as to expose the adhesive layer of the first wall to mount the first wall of the mounting element on the surface.

13. A device as defined in claim 10, wherein said mounting element has a second wall which is spaced from said first wall so as to form said pocket-shaped receptacle therebetween.

14. A device as defined in claim 13, wherein said second wall has a slot for receiving a projection of said suction element when the suction element is inserted in said pocket-shaped receptacle of said mounting element.

15. A device as defined in claim 10, wherein said mounting element has an axis, said pocket-shaped receptacle being open at one radial side of said axis and substantially closed at the other radial side of said axis.

16. (canceled)

17. A device as defined in claim 10, wherein said suction element is flexible so that when it is inserted in said pocket-shaped receptacle it is compressed and firmly held in said pocket-shaped receptacle.

18. A device as defined in claim 17, wherein said suction element is formed to be also mountable on the surface separately from said mounting element when said suction element is removed from said pocket-shaped receptacle of said mounting element so that the part is supported on the surface only by said suction element.

19. A device as defined in claim 11, wherein said first wall of said mounting element has two opposite surfaces including a first side which faces said receptacle and on which said suction element is supported and a second opposite side which is adapted to face the surface and on which said adhesive layer is provided.
